(19) United States
(12) Patent Application Publication
(10) Pub. No.: US 2015/0101457 A1
(43) Pub. Date: Apr. 16, 2015

(54) ADJUSTABLE WRENCH

(71) Applicant: Jun-Fan CHEN, Taichung City (TW)

(72) Inventor: Jun-Fan CHEN, Taichung City (TW)

(21) Appl. No.: 14/055,209

(22) Filed: Oct. 16, 2013

(51) Int. Cl. B25B 13/28

(52) U.S. Cl. CPC B25B 13/28
USPC 81/111

(57) ABSTRACT

An adjustable wrench is provided. The adjustable wrench includes a main body extended and formed with a fixed jaw having a first clamping face. An arc-shaped sliding space is formed between the main body and the fixed jaw. A gear member is rotatably disposed in the main body. A part of the gear member is revealed for allowing the teeth to partially reach to within the sliding space. An end of the movable jaw is pivotally connected to a free end of the fixed jaw. A guiding rib of the movable jaw has a toothed row to mesh with the gear member. The movable jaw has a second clamping face, and a clamping space is formed between the first and second clamping faces. When the gear member is driven by a tool to rotate, the clamping space can be quickly adjusted.

### BACKGROUND OF THE INVENTION

1. Field of the Invention

The present invention relates to an adjustable wrench.

2. Description of the Prior Art

The conventional box end wrenches are closed ended, so if a user wants to rotate different sizes of workpieces, he/she needs various box end wrenches in accordance with various sizes of workpieces.

Regarding the above-mentioned disadvantage, among open-ended wrenches, there are many open-ended movable wrenches with movable jaws, and the opening width of the wrench can be adjusted according to various sizes of workpieces. However, because the open-ended wrench has a side opening, it is less stable during the operation, and when a user operates an open-ended wrench to rotate a workpiece with great strength, the workpiece may even slip off from the opening.

Therefore, the industry has developed adjustable box end wrenches as disclosed in TW M376388 and TW M368523, which include a main body, a fixed jaw and a movable jaw. The movable jaw is pivotally connected to the fixed jaw, and an opening width is formed between the movable jaw and the fixed jaw. An end of the movable jaw remote from the pivoting region is connected to an adjusting member of the main body. Through selectively loosing the connection between the adjusting member and the movable jaw, the movable jaw is swingable relative to the fixed jaw so as to adjust the opening width. After the adjustment is finished, the adjusting member and the movable jaw will be fixedly connected again.

However, this kind of device has many disadvantages. First, the structure of adjusting member is too complex, and the main body needs to be formed with a space for the adjusting member to be disposed in; thus, it is inconvenient to manufacture and assemble this kind of device. Second, a switch of the adjusting member is revealed outside the main body. It would be dangerous if a user accidentally touches the switch and loosen the connection between the movable jaw and the adjusting member. Furthermore, the connecting force between the adjusting member which can be selectively loosened and the movable jaw is not strong enough; and after years of usage, the adjusting member may have problems such as abrasion, loosening and elastic fatigue. These problems may become threats to users' safety.

The present invention is, therefore, arisen to obviate or at least mitigate the above-mentioned disadvantages.

### SUMMARY OF THE INVENTION

The main object of the present invention is to provide an adjustable wrench, which can quickly adjust a clamping space and has better structural intensity.

To achieve the above and other objects, the present invention provides the adjustable wrench, including a main body, a gear member and a movable jaw.

An end of the main body is extended and formed with a fixed jaw. The fixed jaw has a free end and a fixed end corresponding to the free end. The fixed jaw is further formed with a first clamping face. The first clamping face is substantially polygonal. A sliding space is formed between the main body and the fixed jaw, and the sliding space is arc-shaped. The main body has a containing space, and the containing space has an opening toward the sliding space.

The gear member is rotatably disposed in the containing space, and a rim of the gear member has a plurality of teeth. A part of the gear member is revealed from the opening for allowing the teeth to partially reach to within the sliding space. The gear member further has a driving portion, and the driving portion can be provided for connection of a driving tool therewith so as to drive the gear member to rotate.

The movable jaw has a pivoting end and a movable end corresponding to the pivoting end. The movable jaw is pivotally connected with the free end of the fixed end with its pivoting end. The movable end is extended and formed with a guiding rib whose shape corresponds to that of the sliding space. A side of the guiding rib is formed with a toothed row for meshing with the gear member. The movable jaw has a second clamping face facing the first clamping face. The second clamping face is substantially polygonal. A clamping space is formed between the first and second clamping faces. When the gear member is driven to rotate, the teeth of the gear member will drive the guiding rib to slide within the sliding space and change dimensions of the clamping space.

Given the above, the width and dimensions of the clamping space of the adjustable wrench of the present invention can be quickly adjusted. Besides, the present invention has a simple structure, so the problem that users may accidentally touch the switch can be avoided. The gear member is meshed with the movable jaw, so the problem that a latching member is also used to be meshed with the movable jaw and prone to abrasion due to receiving too much force can be avoided.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective breakdown drawing of the present invention;

FIG. 2 is a partial perspective breakdown drawing of the present invention;

FIG. 3 is a drawing showing the present invention in use;

FIGS. 4 and 5 are front views of the present invention in different operating states.

### DETAILED DESCRIPTION OF THE PREFERRED EMBODIMENTS

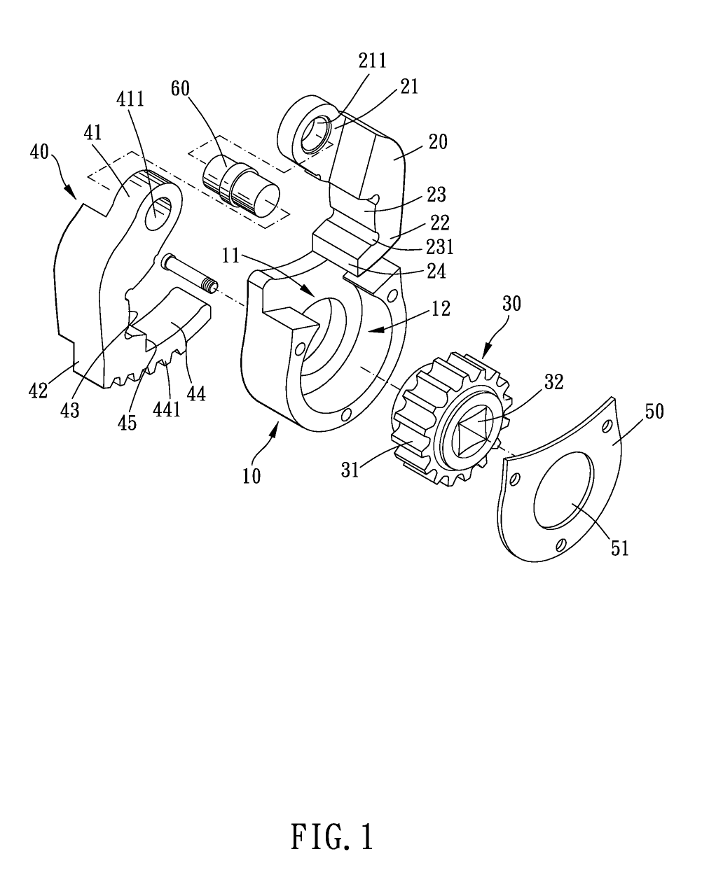

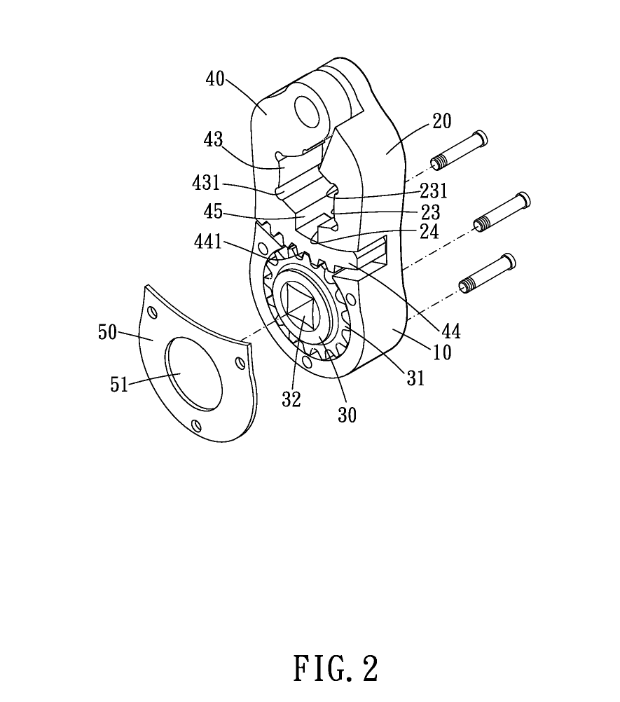

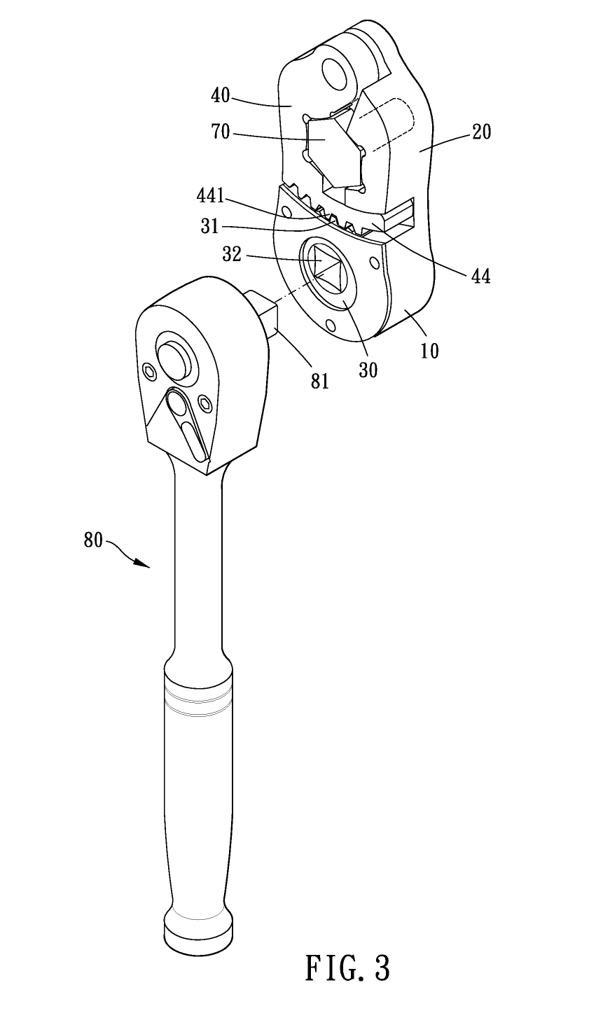

Please refer to FIGS. 1 to 5 for an adjustable wrench of the present invention, including a main body, a gear member and a movable jaw.

An end of the main body 10 is extended and formed with a fixed jaw 20, and the fixed jaw 20 has a free end 21 and a fixed end 22 corresponding to the free end 21. A first clamping face 23 is formed between the free end 21 and the fixed end 22 of the fixed jaw 20. The first clamping face 23 is substantially polygonal, and preferably, the first clamping face includes at least one included angled portion. A corner of the included angled portion is further recessed with a shallow trench 231. A sliding space 11 is formed between the main body 10 and the fixed jaw 20, and a contour of the sliding space 11 is arc-shaped. In addition, the main body 10 has a containing space 12, and the containing space 12 has an opening toward the sliding space 11. Preferably, the containing space 12 has a side opening A lid body 50 is disposed on the main body 10 to cover the containing space 12, wherein the lid body 50 is formed with a through hole 51. The lid body 50 and the main body 10 are formed with holes in corresponding positions, and screw pieces are disposed through the holes to fixedly screw the lid body 50 to the main body 10.

The gear member 30 is rotatably disposed in the containing space 12. A rim of the gear member 30 has a plurality of teeth 31, and a part of the gear member 30 is revealed from the opening of the containing space 12 for allowing the teeth 31 to partially reach to within the sliding space 11. The gear member 30 has a driving portion, the driving portion is provided for connection of a driving tool 80 so as to drive the gear member 30 to rotate, wherein the driving portion and the through hole 51 of the lid body 50 are correspondingly arranged, so the driving tool 80 can be disposed through the through hole 51 to connect to the driving portion. In the main embodiment of the present invention, the driving portion is a polygonal hole 32 provided for being inserted and rotated by a driving tool 80 which has a polygonal connecting portion 81.

The movable jaw 40 a pivoting end 41 and a movable end 42 corresponding to the pivoting end 41. The movable jaw 40 is pivotally connected to the free end 21 of the fixed jaw 20 with its pivoting end 41, and the movable end 42 is extended and formed with a guiding rib 44 whose shape corresponds to that of the sliding space 11. That is, a side of the guiding rib 44 facing the main body 10 is substantially arc-shaped, and a side of the guiding rib 44 is formed with a toothed row 441 provided for meshing with the teeth 31 of the gear member 30. Preferably, the toothed row 441 includes a plurality of teeth arranged equidistantly. The movable jaw 40 has a second clamping face 43 facing the first clamping face 23, and the second clamping face 43 is substantially polygonal. Preferably, the second clamping face 43 includes at least one included angled portion, and a corner of the included angled portion of the second clamping face 43 is recessed with a shallow trench 431. A clamping space is formed between the first clamping face 23 and the second clamping face 43. The shape of the clamping space substantially corresponds to that of a workpiece 70 to be clamped. When the gear member 30 is driven to rotate, the teeth 31 of the gear member 30 will drive the guiding rib 44 to slide within the sliding space 11 so as to change dimensions of the clamping space.

In the main embodiment of the present invention, either of the free end 21 of the fixed jaw 20 and the pivoting end 41 of the movable jaw 40 is formed with a pivotal hole 211, 411. A pivotal member 60 is disposed through the two pivotal holes 211, 411 and pivotally connected the fixed jaw 20 with the movable jaw 40. The arc-shaped contour of the sliding space 11 of the main body 10 is overlapped with a phantom circle whose center is located at the pivotal member 60 so as to allow a sliding path of the guiding rib 44 to correspond to a swinging path of the movable jaw 40. On the other hand, a first abutting portion 24 is formed on the fixed end 22 of the fixed jaw 20, and a second abutting portion 45 is formed on the movable end 42 of the movable jaw 40. When the first abutting portion 24 and the second abutting portion 45 are abutted against each other, the movable jaw 40 can be stopped from swinging toward the fixed jaw 20 so as to limit the range within which the movable jaw 40 swings.

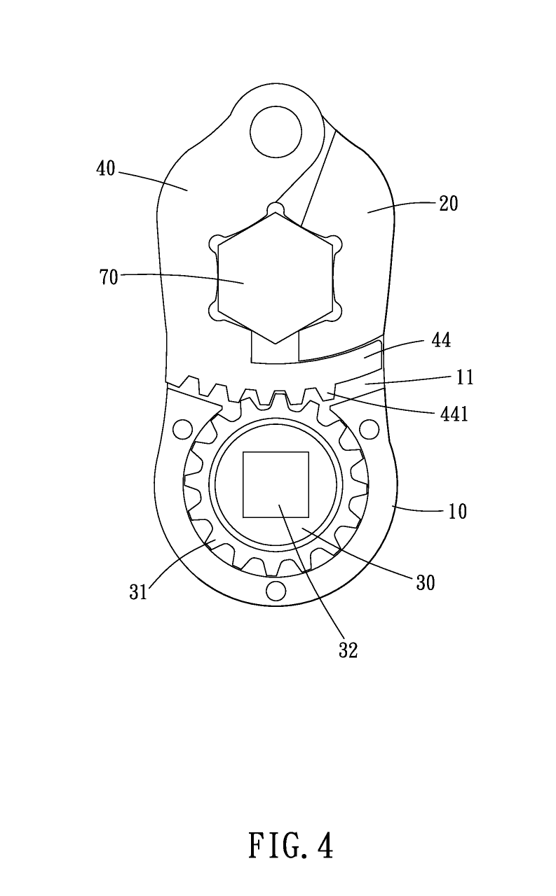

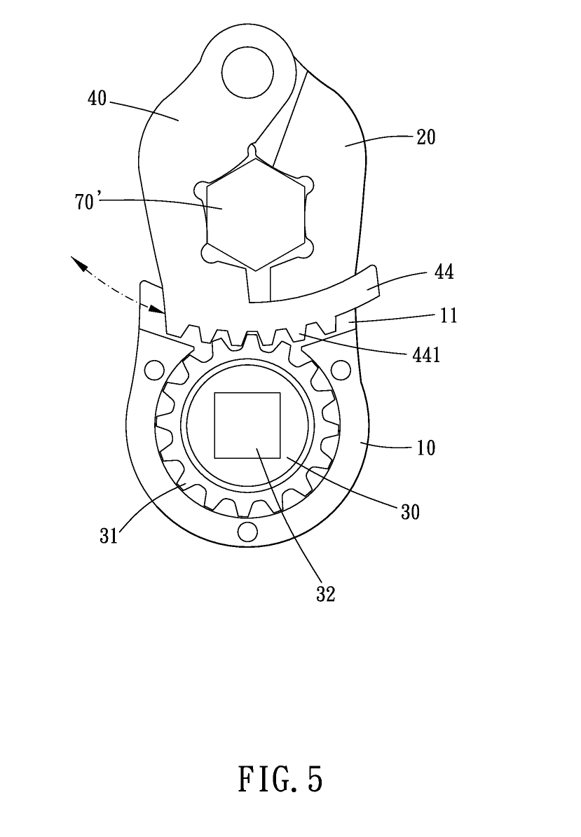

In practice, the clamping space is provided for clamping a workpiece 70, 70′, such as a screw, a nut or the like. If the width or the dimensions of the clamping space needs to be changed to firmly clamp different sizes of workpieces 70, 70′, a user only needs a driving tool 80 to adjust. Through the connection between a connecting portion 81 of the driving tool 80 and the driving portion of the gear member 30, the driving tool 80 can be driven to rotate the gear member 30, and the rotation of the gear member 30 will cause the teeth 31 to drive the toothed row 441 of the guiding rib 44 to move. When the guiding rib 44 moves away from the fixed jaw 20, the width of the clamping space becomes larger. As shown in FIG. 4, when the guiding rib 44 moves toward the fixed jaw 20, the width of the clamping space becomes smaller. As shown in FIG. 5, by doing so, the dimensions of the clamping space can be changed in accordance with various requirements. Besides, corners of the first clamping face 23 and the second clamping face 43 are recessed with shallow trenches 231, 431; therefore, when the workpiece 71, 71′ is positioned in the clamping space, the corners of the fixed jaw 20 or the movable jaw 40 are uneasy to abrade with the workpiece 71, 71′ so as to prevent the abrasion of the workpiece 71, 71′. In addition, the shallow trenches 231, 431 are designed to cooperate with the workpieces 71, 71′ with different outer diameters, so the contour of the clamping space can cooperate with the workpieces 71, 71′ with various outer diameters.

Given the above, the adjustable wrench of the present invention has a simple structure, so it is easy to be manufactured and assembled. The gear member is hidden in the main body, so the problems that users may accidentally touch the gear member and that the movable jaw may be swung can be avoided so as to make sure that the dimensions of the clamping space are fixed and that the workpiece is stably positioned in the clamping space. Most importantly, via the adjustable movable jaw, the adjustable wrench of the present invention has no disadvantages of a box end wrench box end wrench which has fixed dimensions. Through simple rotation and drive, the dimensions of the clamping space can be quickly changed to cooperate with different sizes of workpieces. Besides, the movable jaw can be swung outward before the workpiece is positioned in the clamping space to make the clamping space larger. When the clamping space becomes larger, the workpiece can be positioned in the clamping space easily. Then, the gear member is rotated to allow the movable jaw to swing toward the fixed jaw to clamp the workpiece. By utilizing the adjustable wrench of the present invention, users can quickly position the workpiece and firmly and effectively clamp the workpiece. In addition, the row of the teeth of the movable jaw is selectively meshed with one of the teeth of the gear member, so the problem that the teeth of the gear member are abraded due to long-term mesh can be avoided.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustable wrench, including:
a main body, an end thereof extended and formed with a fixed jaw, the fixed jaw having a free end and a fixed end corresponding to the free end, the fixed jaw further formed with a first clamping face, the first clamping face being substantially polygonal, a sliding space formed between the main body and the fixed jaw, the sliding space being arc-shaped, the main body having a containing space, the containing space having an opening toward the sliding space;
a gear member, rotatably disposed in the containing space, the rim of the gear member having a plurality of teeth, a part of the gear member revealed from the opening for allowing the teeth to partially reach to within the sliding space, the gear member further having a driving portion, the driving portion provided for connection of a driving tool therewith so as to drive the gear member to rotate;
a movable jaw, having a pivoting end and a movable end corresponding to the pivoting end, the movable jaw pivotally connected to the free end of the fixed jaw with its pivoting end, the movable end extended and formed with a guiding rib whose shape corresponds to that of the sliding space, one side of the guiding rib formed with a toothed row provided for meshing with the gear member, the movable jaw having a second clamping face facing the first clamping face, the second clamping face being substantially polygonal, a clamping space being formed between the first and second clamping faces;
wherein as the gear member is driven to rotate, the teeth of the gear member will drive the guiding rib to slide within the sliding space to change dimensions of the clamping space.

2. The adjustable wrench of claim 1, wherein the containing space has a side opening, a lid body is disposed on the main body to cover the side opening, wherein the lid body is formed with a through hole, and the through hole and the driving portion of the gear member are correspondingly arranged.

3. The adjustable wrench of claim 1, wherein the fixed jaw has a first abutting portion at the fixed end, the movable jaw has a second abutting portion at the movable end, and when the first abutting portion and the second abutting portion are abutted against each other, the movable jaw is unpermitted to swing toward the fixed jaw.

4. The adjustable wrench of claim 1, wherein the driving portion is a polygonal hole.

5. The adjustable wrench of claim 1, wherein the first clamping face includes at least one included angled portion, a corner of the included angled portion of the first clamping face is further recessed with a shallow trench, the second clamping face includes at least one included angled portion, and a corner of the included angled portion of the second clamping face is recessed with a shallow trench.

6. The adjustable wrench of claim 1, wherein either of the free end of the fixed jaw and the pivoting end of the movable jaw is formed with a pivotal hole, and a pivotal member is disposed through the two pivotal holes to pivotally connect the fixed jaw with the movable jaw.

7. The adjustable wrench of claim 6, wherein an arc-shaped contour of the sliding space is overlapped with a phantom circle whose center is located at the pivotal member.

8. The adjustable wrench of claim 1, wherein the toothed row includes a plurality of teeth arranged equidistantly.
